(19) United States
(12) Patent Application Publication
(10) Pub. No.: US 2024/0393001 A1
(43) Pub. Date: Nov. 28, 2024

(54) WIND DUCT WITH SILENCER

(71) Applicant: FUJIFILM Corporation, Tokyo (JP)

(72) Inventors: Shogo YAMAZOE, Ashigarakami-gun (JP); Tomohiro TAKAHASHI, Ashigarakami-gun (JP); Shinya HAKUTA, Ashigarakami-gun (JP); Yuichiro ITAI, Ashigarakami-gun (JP); Yoshihiro SUGAWARA, Ashigarakami-gun (JP)

(73) Assignee: FUJIFILM Corporation, Tokyo (JP)

(21) Appl. No.: 18/798,340

(22) Filed: Aug. 8, 2024

Related U.S. Application Data
(63) Continuation of application No. PCT/JP2022/045302, filed on Dec. 8, 2022.

(30) Foreign Application Priority Data
Mar. 22, 2022 (JP) 2022-045293

(51) Int. Cl. F24F 13/02; E04F 17/04; F24F 13/24

(52) U.S. Cl. CPC F24F 13/0263; E04F 17/04; F24F 13/24; F24F 2013/242

(57) ABSTRACT

There is provided a wind duct with a silencer that can efficiently reduce sound propagated to a blowing target including noise generated in a wind duct during blowing.

The wind duct with a silencer of the present invention includes the wind duct that is connected to a blowing source and a silencer that reduces sound released from an exit of the wind duct. The silencer is disposed at a position closer to the exit among the blowing source and the exit, and a frequency of a primary silencing peak of the silencer is within a frequency band of sound generated in the wind duct due to blowing in the wind duct.

### CROSS-REFERENCE TO RELATED APPLICATIONS

This application is a Continuation of PCT International Application No. PCT/JP2022/045302 filed on Dec. 8, 2022, which claims priority under 35 U.S.C. § 119 (a) to Japanese Patent Application No. 2022-045293 filed on Mar. 22, 2022. The above applications are hereby expressly incorporated by reference, in their entirety, into the present application.

### BACKGROUND OF THE INVENTION

### 1. Field of the Invention

The present invention relates to a wind duct with a silencer.

### 2. Description of the Related Art

In a case where wind is blown into a building such as a house and an apartment from an air conditioner, a blower, or the like through a wind duct such as a duct, for example, noise or the like caused by the operation of the blower can be propagated to a blowing target through the wind duct. A technique for silencing such noise at a middle position of the wind duct has already been developed, and a technique disclosed in JP2004-069173A is given an example thereof.

In an air conditioning and heating machine disclosed in JP2004-069173A, a radial fan assembly is provided at an outdoor unit and takes in outdoor air to send wind to an indoor unit. In this case, the air sent to the indoor unit passes through a supply and exhaust duct, and a muffler provided at the supply and exhaust duct reduces sound transmitted through the supply and exhaust duct.

### SUMMARY OF THE INVENTION

In a blowing system for a building, a blowing amount is increased in some cases for the purpose of improving efficiency of air conditioning or ventilation or the like. On the other hand, the size (diameter) of the wind duct tends to be set to be smaller due to various restrictions such as a limited disposition space for a duct or the like. For such circumstances, in the blowing system for a building, a case where a wind speed in the wind duct increases is assumed.

In a case where the wind speed in the wind duct is relatively high and the diameter of the wind duct is small, there is a possibility in which noise caused by turbulence in the wind duct (hereinafter, called fluid noise) is generated in the wind duct, and the fluid noise propagates to a blowing target through the wind duct. For this reason, in a case of silencing the sound (noise) propagating in the wind duct, it is necessary to consider the fluid noise. Specifically, it is required to appropriately dispose the silencer such that the propagation of fluid noise is suppressed.

The present invention has been devised in view of the circumstances, and an object thereof is to solve the following problem.

The object of the present invention is to solve the problem of the related art and to provide a wind duct with a silencer that can efficiently reduce sound propagated to a blowing target including noise generated in a wind duct during blowing.

In order to achieve the object, the present invention has the following configurations.
[1] A wind duct with a silencer comprising a wind duct that is connected to a blowing source and a silencer that reduces sound released from an exit of the wind duct, in which the silencer is disposed at a position closer to the exit among the blowing source and the exit, and a frequency of a primary silencing peak of the silencer is within a frequency band of sound generated in the wind duct due to blowing in the wind duct.
[2] The wind duct with a silencer according to [1], in which the wind duct penetrates a wall separating two spaces, and the silencer is disposed in a space where the blowing source is disposed, among the two spaces.
[3] The wind duct with a silencer according to [2], in which the wind duct penetrates the wall constituting a building.
[4] The wind duct with a silencer according to any one of [1] to [3], in which the wind duct is connected to a fan that is the blowing source.
[5] The wind duct with a silencer according to any one of [1] to [4], in which a sound absorbing material is included inside the silencer, and the sound absorbing material is composed of a material which is a non-metallic body and which is other than an inorganic substance.
[6] The wind duct with a silencer according to [5], in which a part of the wind duct is provided in the silencer, and in the silencer, the sound absorbing material is disposed at a position surrounding the part of the wind duct provided in the silencer.
[7] The wind duct with a silencer according to any one of [1] to [6], in which the silencer includes a container made of a resin.
[8] The wind duct with a silencer according to any one of [1] to [7], in which a wind speed calculated based on an amount of wind flowing in the wind duct per unit time and a cross-sectional area of the wind duct is 1 m/s or more.
[9] The wind duct with a silencer according to any one of [1] to [8], in which an inner peripheral surface of the wind duct includes an uneven region where unevenness is formed.
[10] The wind duct with a silencer according to [2] or [3], in which the silencer is attached to a portion of the wind duct, which is disposed along the wall.

In the wind duct with a silencer according to an embodiment of the present invention, the silencer is disposed at the position closer to the exit of the wind duct, and the frequency of the primary silencing peak of the silencer is within the frequency band of fluid noise generated in the wind duct. Accordingly, sound propagated to a blowing target including the fluid noise can be efficiently reduced.

### BRIEF DESCRIPTION OF THE DRAWINGS

FIG. 1 is a view showing a blowing system in which a wind duct with a silencer according to one embodiment of the present invention is used.

FIG. 2 is a schematic cross-sectional view showing a silencer of the wind duct with a silencer according to one embodiment of the present invention.

FIG. 3 is a view showing a first modification example of the silencer.

FIG. 4 is a view showing a second modification example of the silencer.

FIG. 5 is a view showing a third modification example of the silencer.

FIG. 6 is a view showing a system that measures fluid noise (measurement system).

FIG. 7 is a graph showing a relationship between the fluid noise and a wind speed.

FIG. 8A shows a model used in a simulation related to energy of turbulence generated on an interior wall of a wind duct.

FIG. 8B is a graph showing a relationship between a diameter of the wind duct and the energy of the turbulence generated in the wind duct.

FIG. 9A shows a model used in a simulation related to noise in a case where a virtual sound source is disposed in the wind duct.

FIG. 9B is a graph showing a relationship between the diameter of the wind duct and a noise amount.

FIG. 10 is a graph showing a relationship between a silencing spectrum of the silencer and a spectrum of the fluid noise.

FIG. 11 is a graph showing the spectrum of the fluid noise at a wind speed of 9 m/s and the silencing spectrum of the silencer.

FIG. 12 is a view showing a measurement system of fluid noise in example 1.

FIG. 13 is a view showing a measurement system of fluid noise in comparative example 1.

FIG. 14 is a graph showing a spectrum of noise measured for each of example 1, comparative example 1, and reference.

### DESCRIPTION OF THE PREFERRED EMBODIMENTS

A wind duct with a silencer according to an embodiment of the present invention will be described in detail below with reference to a suitable embodiment shown in the accompanying drawings. The following embodiment is merely an example in order to facilitate understanding of the present invention and does not limit the present invention. That is, the configuration of the present invention can be changed or improved from the following embodiment without departing from the gist of the present invention.

In addition, the material, the shape, or the like of each member used in order to implement the present invention can be set in any manner in accordance with the purpose of use of the present invention and the technical level or the like at the time of implementation of the present invention. In addition, the present invention includes an equivalent thereof.

In addition, in the present specification, a numerical range represented by using “to” means a range including numerical values written before and after “to” as a lower limit value and an upper limit value.

In addition, in the present specification, the terms “orthogonal”, “perpendicular”, and “parallel” include a range of errors accepted in the technical field to which the present invention belongs. For example, the terms “orthogonal”, “perpendicular”, and “parallel” in the present specification mean being in a range of less than +10° with respect to being orthogonal, perpendicular, or parallel in a strict sense. An error from being orthogonal or parallel in a strict sense is preferably 5° or less and more preferably 3° or less.

In addition, in the present specification, the meanings of “the same”, “identical” and “equal” may include a range of errors generally accepted in the technical field to which the present invention belongs.

In addition, in the present specification, the meanings of “the entire”, “any”, and “all” can include a range of errors generally accepted in the technical field to which the present invention belongs and can include a case of, for example, 99% or more, 95% or more, or 90% or more in addition to a case of 100%.

In addition, “silencing” in the present invention is a concept including both meanings of sound insulation and sound absorption. Sound insulation means blocking sound, in other words, not allowing transmission of sound. Sound absorption means reducing reflected sound, that is, absorbing sound (acoustics).

### Regarding Basic Configuration of Wind Duct With Silencer According to Embodiment of Present Invention

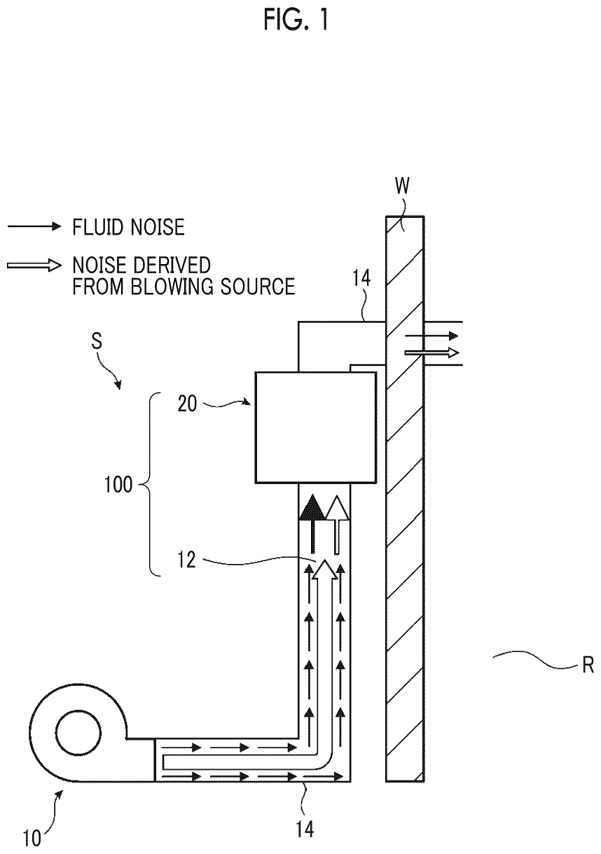

A basic configuration of the wind duct with a silencer according to one embodiment of the present invention (hereinafter, referred to as the present embodiment) will be described with reference to FIGS. 1 to 5. In the following description, a blowing direction means a direction in which wind flows in a wind duct toward an exit. In addition, a downstream side means an exit side of the air wind duct in the blowing direction, and the upstream side means an entrance side of the air wind duct (specifically, a side on which the blowing source 10 described below is disposed).

The wind duct with a silencer according to the present embodiment (hereinafter, referred to as a wind duct with a silencer 100) is used in a blowing system, particularly a blowing system S for a building. The blowing system S is used in order to transport (blow) wind to a predetermined space (for example, a room or the like) in a building for the purpose of air conditioning, ventilation, or the like. The building include a detached house, cach dwelling unit in an apartment such as condominium, a store such as a restaurant and a shop, and a facility such as a hospital, a department store, and a movie theater.

The term “wind” is an artificial air or a flow of a gas (air flow). Although the composition of air or a gas constituting wind and a ratio between respective components are not particularly limited, description will be made below assuming a case where normal air is blown.

As shown in FIG. 1, the blowing system S is composed of the blowing source 10 and the wind duct with a silencer 100. As shown in FIG. 1, the wind duct with a silencer 100 comprises a wind duct 12 connected to the blowing source 10 and a silencer 20 that reduces sound (noise) released from an exit of the wind duct 12 during blowing.

The blowing source 10 is a device that comprises an electric motor such as a motor and that operates and blows wind in response to starting of the electric motor and is specifically a blowing fan constituting an air conditioner or a blowing fan for ventilation. As the fan, a well-known fan such as an axial fan (propeller fan), a sirocco fan, a turbo fan, a centrifugal fan, or a line flow fan (registered trademark) can be used.

The wind duct 12 is a flow passage for wind from the blowing source 10 and is formed by a wind duct forming member 14 such as a duct, a pipe, and a hose. The material, the structure, and the like of the wind duct forming member 14 are not particularly limited. From a perspective of facilitating the laying of the wind duct 12, for example, a flexible hose such as a vinyl hose, a flexible hose, and a Ty-Duct hose may be used as the wind duct forming member 14.

One end (an end on the upstream side) of the wind duct 12 is connected to the blowing source 10, specifically, an outlet of the fan. The other end (an end on the downstream side) of the wind duct 12 is disposed in a predetermined space in a building corresponding to a blowing target (hereinafter, a blowing target room R). To describe more specifically, the blowing target room R is an indoor space, and as shown in FIG. 1, the blowing target room R and an outdoor space are partitioned with an outer wall W (corresponding to a wall) constituting the building. The wind duct 12 is disposed along the outer wall W separating these two spaces and penetrates the outer wall W at a suitable position to enter the blowing target room R. That is, a through-hole through which the wind duct 12 (in a strict sense, the wind duct forming member 14) penetrates is formed in the outer wall W. The size (diameter) of the through-hole is, for example, 150 mm or less.

The wall through which the wind duct 12 penetrates is not limited to the outer wall W that partitions into the indoors and the outdoors and may be, for example, a ceiling wall that partitions the inside of the building into a space behind the ceiling and a space under the ceiling (room) in the building. That is, the wind duct 12 may be disposed along the ceiling wall behind the ceiling and may penetrate the ceiling wall to enter the room at a suitable position.

The silencer 20 reduces sound propagating in the wind duct 12. The silencer 20 may be provided with respect to the wind duct 12 and may be provided at a middle position of the wind duct 12, for example, as shown in FIG. 1. However, the present invention is not limited thereto, and for example, the silencer 20 may be connected to a terminal portion (downstream end part) of the wind duct forming member 14. In other words, a ventilation passage (specifically, an in-expansion portion wind duct 32 to be described below) in the silencer 20 may constitute a downstream end part of the wind duct 12.

An attachment point, an attachment method of the silencer 20, and the like are not particularly limited. For example, for a reason that the silencer 20 is easily held at a predetermined height, as shown in FIG. 1, the silencer 20 may be attached to a portion of the wind duct 12 disposed along the outer wall W of the building.

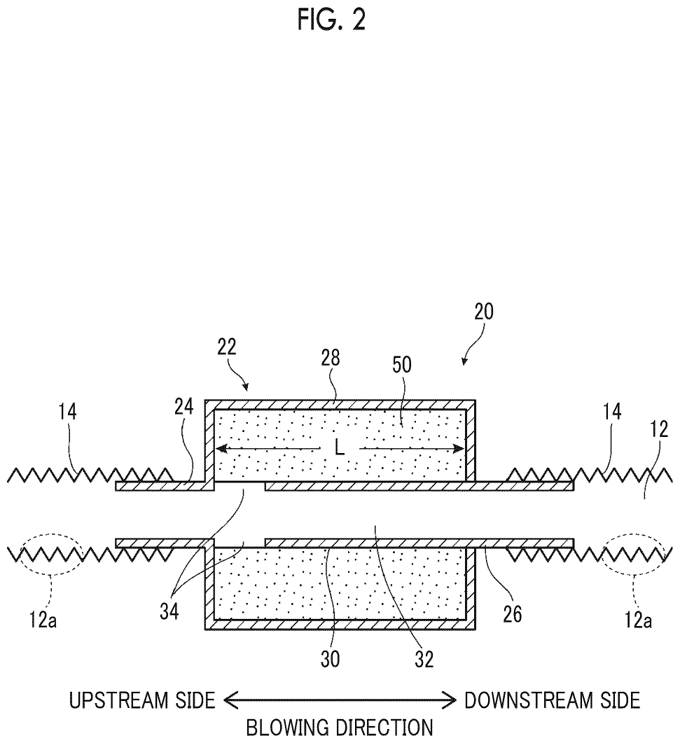

As shown in FIG. 2, the silencer 20 has a container 22 and a sound absorbing material 50 disposed in the container 22. As shown in FIG. 2, the container 22 has a tubular entrance-side connecting portion 24, an exit-side connecting portion 26, and an expansion portion 28 disposed between the two connecting portions 24 and 26.

The wind duct forming member 14 extending from the blowing source 10 is connected to the entrance-side connecting portion 24, and the wind duct forming member 14 connected to the exit-side connecting portion 26 extends to the exit (that is, the blowing target) of the wind duct 12. An inner space of each of the entrance-side connecting portion 24 and the exit-side connecting portion 26 forms a portion of the wind duct 12. As shown in FIG. 2, the inner space of the exit-side connecting portion 26 may be disposed on an extension line of the inner space of the entrance-side connecting portion 24 or may be disposed at a position shifted from the extension line (a position shifted in an up-down direction of the paper surface in FIG. 2).

The expansion portion 28 forms a main body of the container 22 and has a cavity (expanded space) having a cross-sectional area more expanded than that of the wind duct 12. Herein, the term “cross-sectional area” is a size of a cross section, and the cross section is a cross section of which a normal direction is the blowing direction. The expansion portion 28 comprises a container wall surrounding the entire periphery of the cavity. In a portion of the container wall forming an end part on the upstream side, a hole that is continuous to the inner space of the entrance-side connecting portion 24 is provided, and in a portion of the container wall forming an end part on the downstream side, a hole that is continuous to the exit-side connecting portion 26 is provided.

In addition, in the cavity, a portion that communicates with the inner space of each of the entrance-side connecting portion 24 and the exit-side connecting portion 26 and that constitutes a part of the wind duct 12 is present. To describe specifically, as shown in FIG. 2, in the cavity, an inner sleeve 30 disposed between the entrance-side connecting portion 24 and the exit-side connecting portion 26 is provided. An inner space of the inner sleeve 30 communicates with the inner space of each of the entrance-side connecting portion 24 and the exit-side connecting portion 26. That is, a space in the inner sleeve 30 constitutes a part (hereinafter, the in-expansion portion wind duct 32) of the wind duct 12 inside the expansion portion 28.

Materials constituting the container 22 and the inner sleeve 30 are not particularly limited, and a metal material, a resin material, a paper material, a reinforced plastic material, a carbon fiber, and the like can be used. However, from a perspective of ensuring formability and a degree of freedom in design, the resin material is preferable. That is, as a preferable configuration of the silencer 20, the resin container 22 made of a resin may be included in the silencer 20.

Examples of the resin material include an acrylic resin, polymethyl methacrylate, polycarbonate, polyamide, polyalylate, polyetherimide, polyacetal, polyetheretherketone, polyphenylene sulfide, polysulfone, polyethylene terephthalate, polybutylene terephthalate, polyimide, a copolymer synthetic resin of acrylonitrile, a flame-retardant ABS resin, butadiene, and styrene (ABS resin), polypropylene (PP), triacetylcellulose (TAC), polyethylene (PE), polystyrene (PS), an acrylate sthrene acrylonitrile (ASA) resin, a polyvinyl chloride (PVC) resin, and a polylactic acid (PLA) resin.

Examples of the reinforced plastic material include carbon fiber reinforced plastics (CFRP) and glass fiber reinforced plastics (GFRP).

In addition, as shown in FIG. 2, the sound absorbing material 50 fills a space on an outer side of the inner sleeve 30 (specifically, a portion positioned on a radially outer side of the inner sleeve 30) inside the expansion portion 28, that is, in the cavity. In other words, in the sound absorbing material 50, a hole communicating with the inner space of each of the entrance-side connecting portion 24 and the exit-side connecting portion 26 is formed, and the inner sleeve 30 is inserted into the hole. That is, the sound absorbing material 50 is disposed at a position surrounding the in-expansion portion wind duct 32 in the expansion portion 28.

In addition, in the expansion portion 28, an opening portion 34 is provided at an end part on an entrance-side connecting portion 24 side as shown in FIG. 2. The opening portion 34 is a portion that makes the space filled with the sound absorbing material 50 communicate with the in-expansion portion wind duct 32 and specifically, is a portion in which the inner sleeve 30 is not provided. The opening portion 34 and the space filled with the sound absorbing material 50 are continuous to each other and form a space (hereinafter, referred to as an L-shaped space) that is bent in an L-shape.

The L-shaped space is provided at a position adjacent to the in-expansion portion wind duct 32, and sound propagating in the in-expansion portion wind duct 32 is reduced by the L-shaped space and the sound absorbing material 50 disposed in the space. That is, the silencer 20 is a side branch type silencer, and sound (noise) can be reduced by the L-shaped space formed on the side of the in-expansion portion wind duct 32.

As the sound absorbing material 50, a material that absorbs sound by converting sound energy into thermal energy can be used. Examples of the material constituting the sound absorbing material 50 include porous materials such as a foaming body, a foaming material, and a nonwoven fabric-based sound absorbing material.

Specific examples of the foaming body and the foaming material include foaming urethane foam such as CALMFLEX F manufactured by INOAC CORPORATION and urethane foam manufactured by Hikari Co., Ltd., flexible urethane foam, a ceramic particle sintered material, phenol foam, melamine foam, an insulation board, and polyamide foam.

Specific examples of the nonwoven fabric-based sound absorbing material include a microfiber nonwoven fabric such as Thinsulate manufactured by 3M Company, a plastic nonwoven fabric such as a polyester nonwoven fabric (including a two-layer configuration fabric that has a thin surface-side nonwoven fabric having a high density and a back-side nonwoven fabric having a low density) such as White Kyuon manufactured by TOKYO Bouon and QonPET manufactured by Bridgestone KBG Co., Ltd. and an acrylic fiber nonwoven fabric, a natural fiber nonwoven fabric such as wool and felt, a meltblown nonwoven fabric, a metal nonwoven fabric, a glass nonwoven fabric, a floor mat, and a carpet.

In addition to the description above, various sound absorbing materials, such as a sound absorbing material consisting of a material including a minute amount of air, for example, a sound absorbing material consisting of glass wool, rock wool, a plaster board, a wood wool cement board, and a nanofiber-based fiber, can be used. Examples of the nanofiber-based fiber include a silica nanofiber and an acrylic nanofiber, such as XAI manufactured by Mitsubishi Chemical Corporation.

In a case where a material having hydrophilicity (for example, glass wool) is used among the materials for the sound absorbing material 50 described above, there is a possibility in which mold is generated in the sound absorbing material in a case where high-humidity wind flows in the silencer 20. For a reason of suppressing generation of such mold, the material for the sound absorbing material 50 is preferably a material which is a non-metallic body and which is other than an inorganic substance, and the sound absorbing material 50 composed of a resin fiber having water repellency is more preferable.

In addition, the flow resistivity of the sound absorbing material 50 is preferably 1,000 (Pa×s/m²) to 100,000 (Pa×s/m²). In a case where the sound absorbing material 50 is a laminated structure obtained by overlapping a plurality of layers, the flow resistivity of the entire structure can be measured, and the flow resistivity can be calculated from the thickness of the entire structure.

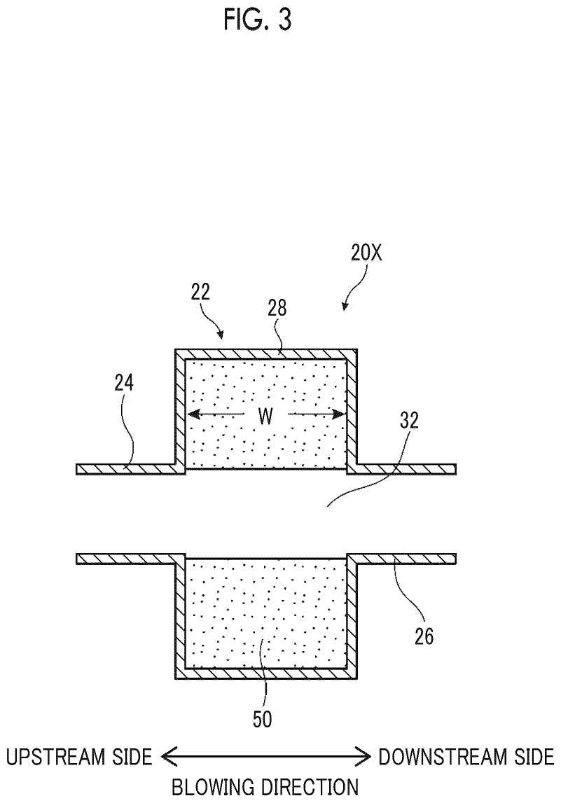

The silencer 20 is not limited to the side branch type silencer shown in FIG. 2, and for example, a silencer 20X having a cavity type structure shown in FIG. 3 may be used. In the silencer 20X, as shown in FIG. 3, the inner sleeve 30 is not comprised, and the in-expansion portion wind duct 32 is in direct contact with the sound absorbing material 50 (in a strict sense, an inner peripheral surface of a hole formed in the sound absorbing material 50).

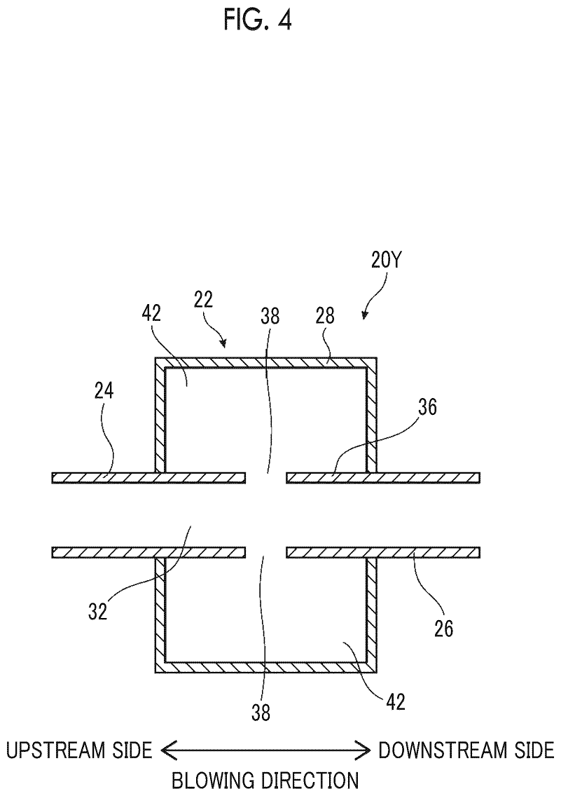

In addition, as the silencer, a resonance type silencer may be used, and for example, a Helmholtz resonance type silencer 20Y shown in FIG. 4 may be used. In the silencer 20Y, a tubular partition member 36 partitions the inside of the expansion portion 28 into the in-expansion portion wind duct 32 and a space on the outer side thereof (hereinafter, a rear space 42), and a Helmholtz resonator is configured by providing a hole 38 in the partition member 36. In the silencer 20Y, in a case where sound having the same frequency as the resonance frequency collides air in the hole 38, the air in the hole 38 and air in the rear space 42 vibrate, and the sound is silenced by converting sound energy into thermal energy due to a viscous loss in this case.

The resonance type silencer may convert the sound energy into the thermal energy through resonance of a film or a board to absorb the sound.

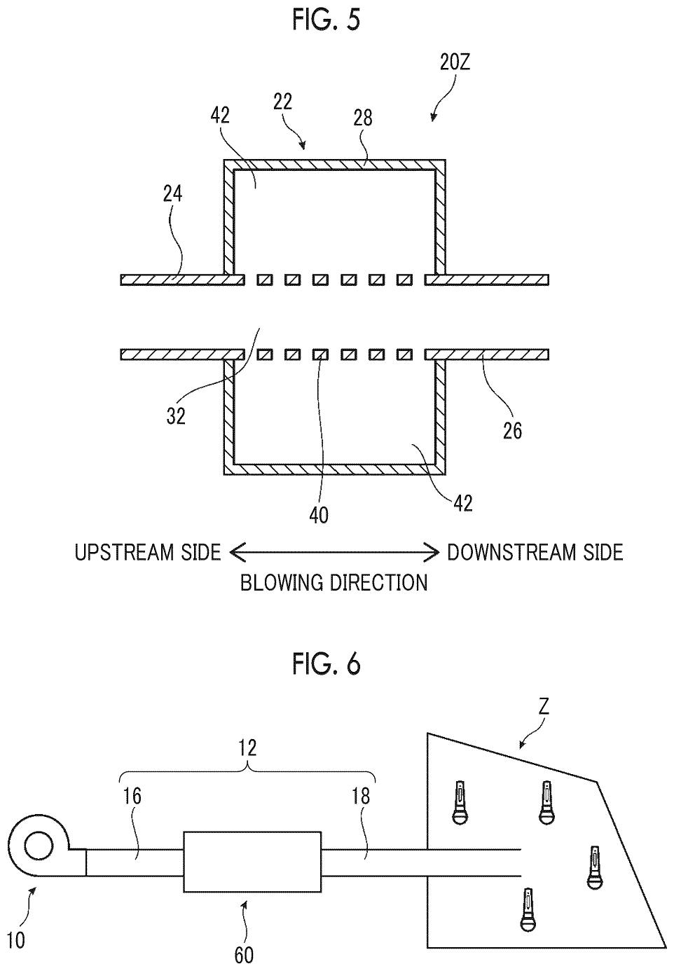

In addition, as the silencer, a silencer 20Z in which a porous plate 40 is used as the partition member 36 may be used as shown in FIG. 5. In the silencer 20Z, the porous plate 40 is a micro perforated plate in which a large number of through-holes having a diameter of approximately 100 μm are formed, and sound is absorbed by micro holes and the space on the outer side (rear space 42). As the micro perforated plate, for example, an aluminum micro perforated plate such as SUONO manufactured by Taisei Kogyo Corporation, a vinyl chloride resin micro perforated plate such as Di-NOC manufactured by 3M Company, and the like can be used.

The number of silencers 20 is not particularly limited, and for example, two or more silencers 20 may be provided at middle positions of the wind duct 12. In this case, a plurality of types of silencers 20, 20X, 20Y, and 20Z may be used in combination.

### Fluid Noise and Countermeasure in Present Embodiment

In the blowing system S, in a case where the fan which is the blowing source 10 is started and blows wind, noise (hereinafter, also referred to as noise derived from the blowing source 10) caused by operating sound of the fan propagates to the downstream side in the wind duct 12. As a method of reducing the noise, in general, the silencer 20 is disposed with respect to the wind duct 12.

On the other hand, a blowing amount is increased in some cases for a reason of enhancing the performance of air conditioning or ventilation by the blowing system S. On the other hand, the diameter of the wind duct 12 tends to be set to a small value due to a restriction such as a space where the wind duct forming member 14 is disposed. In particular, in a case where the wind duct 12 penetrates the outer wall W of the building, it is necessary to set the diameter of the through-hole as small as possible and is set to, for example, 150 mm or less in a general house or a store such as a restaurant. As a result, in the blowing system S for a building, a wind speed in the wind duct 12 tends to gradually increase in recent years.

On the other hand, in a case where the diameter of the wind duct 12 is small, noise (fluid noise) is generated in the wind duct 12 due to blowing in the wind duct 12. In addition, the present inventors have found the following features A and B for the fluid noise.
Feature A: In the spectrum of the fluid noise, a peak is present in a middle band (1 kHz).
Feature B: The intensity (sound pressure) of the fluid noise in the middle band remarkably increases as the diameter of the wind duct 12 decreases, that is, as the wind speed increases.

Herein, the spectrum of the fluid noise is an acoustic spectrum indicating the intensity (sound pressure: the unit is dB) of the fluid noise at each frequency and can be measured by a measurement system shown in FIG. 6.

To describe the measurement system shown in FIG. 6, the blowing source 10 and an entrance of the silencer (hereinafter, a silencer for measurement 60) are connected to each other through a upstream wind duct 16, and a downstream wind duct 18 extends from an exit of the silencer for measurement 60 to a reverberation chamber Z. The upstream wind duct 16 is formed of, for example, a hose, and the downstream wind duct 18 is formed of, for example, a Ty-Duct hose. Then, the blowing source 10 is operated to blow wind, and the wind is caused to flow at a constant amount of wind in each of the upstream wind duct 16, the inside of the silencer for measurement 60, and the downstream wind duct 18, and a sound pressure of sound released from an exit of the downstream wind duct 18 is measured by a plurality of microphones scattered in the reverberation chamber Z. Noise derived from the blowing source 10 is absorbed by the silencer for measurement 60, and fluid noise mainly propagates in the wind duct on the downstream side of the silencer for measurement 60. For this reason, in the measurement system shown in FIG. 6, the sound pressure of the fluid noise can be measured by using the microphones in the reverberation chamber Z.

Regarding the features, the present inventors have performed a measurement test on wind speed dependence of fluid noise. To describe specifically, a wind speed (accurately, an average wind speed) is set to 6 m/s, 9 m/s, 10 m/s, 11 m/s, 12 m/s, and 13 m/s using the measurement system shown in FIG. 6, and the sound pressure of sound released from an end of the downstream wind duct 18 is measured in the reverberation chamber Z. In the measurement test, the blowing source 10 is a sirocco fan, and the upstream wind duct 16 is composed of a transparent vinyl hose (model number: TOUMEI VINYL HOSE 28 x 34-50) manufactured by Chubu Vinyl Industry Co., Ltd. The downstream wind duct 18 is composed of a Ty-Duct hose (product name, Ty-Duct hose N type, model number N-32-20-L6) manufactured by Tiger Polymer Co., Ltd.

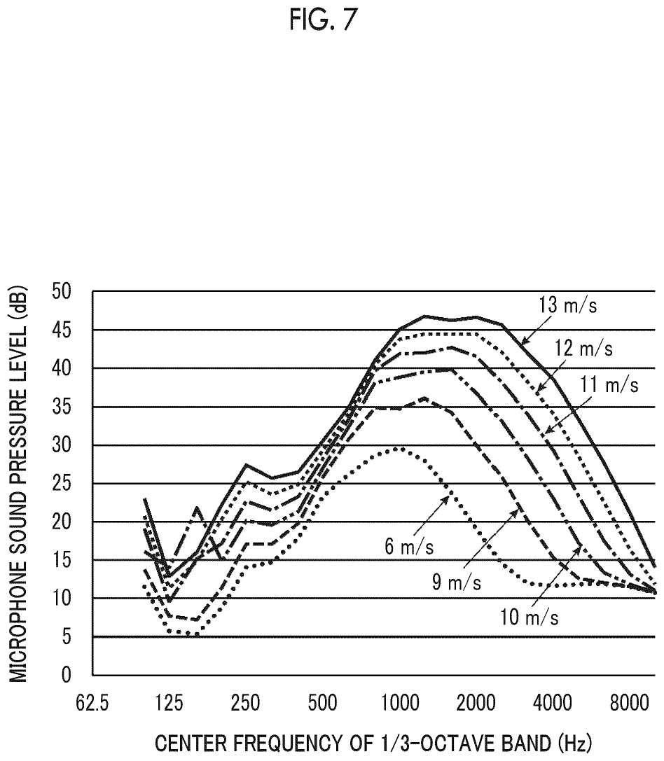

FIG. 7 shows measurement results. As can be seen from FIG. 7, a peak is present in the middle band in the spectrum of fluid noise, and the sound pressure of the fluid noise remarkably increases as the wind speed increases. In addition, it is found that a peak frequency of the fluid noise, specifically, a maximum peak frequency of the fluid noise generated in a Ty-Duct hose shifts to the high frequency side as the wind speed increases.

Herein, feature B includes features from a fluidic perspective and an acoustic perspective. Regarding these features, the present inventors have performed a simulation from a perspective of a fluid and acoustics.

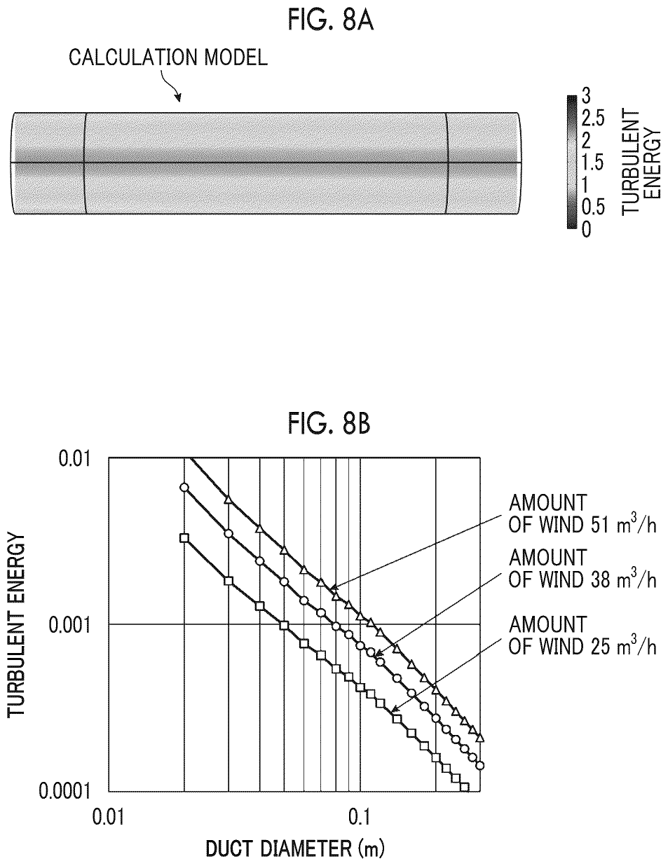

Regarding feature B, a simulation related to energy of turbulence in a duct forming the wind duct is performed using a calculation model having a circular pipe shape shown in FIG. 8A. In the simulation, the diameter and the amount of wind (a blowing amount per unit time) of the duct are changed, and the energy of the turbulence under cach condition is numerically calculated. As a result of the simulation, results shown in FIG. 8B are obtained.

FIG. 8B is a graph showing a relationship between turbulent energy generated in the duct and a duct diameter, in which the horizontal axis shows the duct diameter (the unit is m), and the vertical axis shows the scale of the energy of the turbulence (in a strict sense, a value normalized by the Reynolds number). In addition, FIG. 8B shows a graph in a case where the amount of wind is set to each of 25 m³/h, 38 m³/h, and 51 m³/h.

As can be seen from FIG. 8B, a wind speed in the wind duct increases as the duct diameter decreases, and the energy of the turbulence generated on an interior wall of the wind duct increases significantly as the wind speed increases. In a case where the energy of the turbulence increases, fluid noise (sound generated in the wind duct due to blowing in the wind duct) generated in the wind duct remarkably increases.

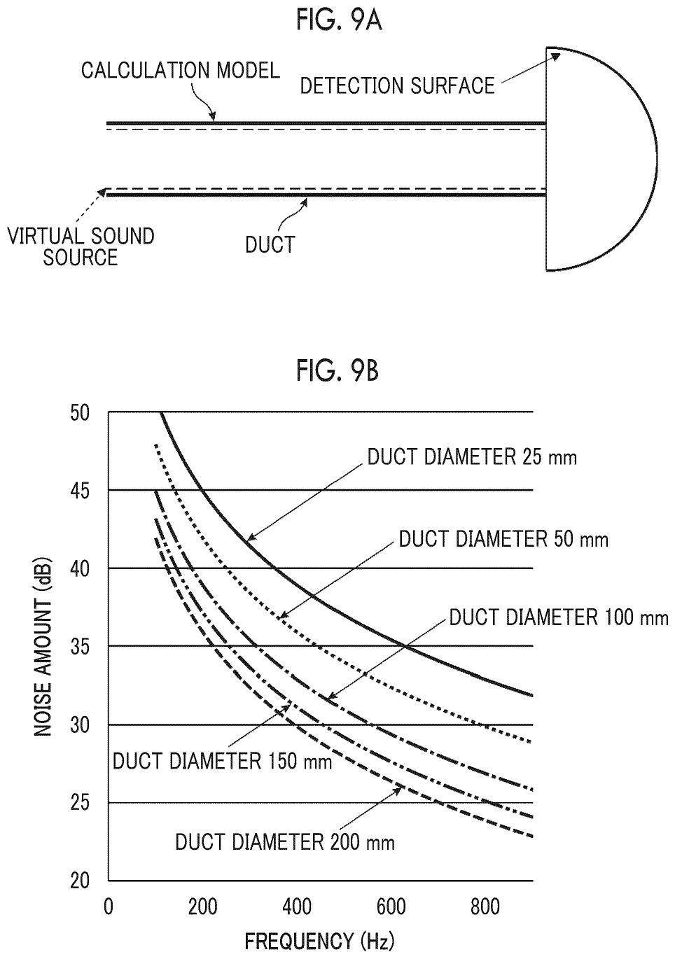

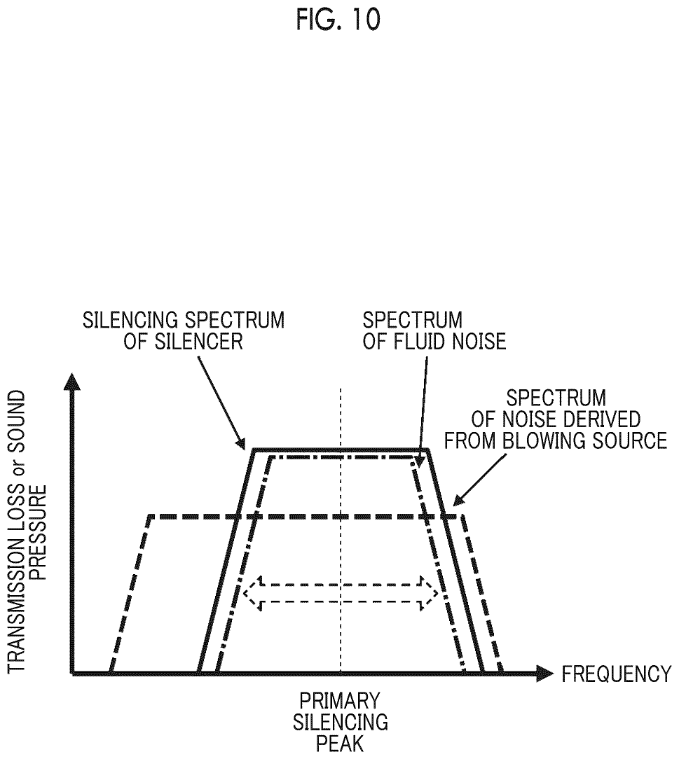

Regarding the acoustic features, the volume (the amplitude of a sound wave) of fluid noise generated in the wind duct is simulated using a calculation model shown in FIG. 9A. In the calculation model of FIG. 9A, for the fluid noise caused by turbulence near the duct interior wall, a virtual sound source (denoted by an underline in FIG. 9A) is disposed on the duct interior wall. Then, of noise emitted from the sound source, the amplitude per unit area of sound (in a strict sense, a sound wave) reaching a hemispherical detection surface disposed at the duct exit is calculated as a noise amount. In addition, the noise amount of the fluid noise is calculated for each duct diameter by changing the duct diameter. In the calculation of the noise amount performed for each duct diameter, a premise condition in which the energy (incident energy) of the sound source is constant is set.

As a result of the simulation, results shown in FIG. 9B are obtained. FIG. 9B is a graph showing a relationship between the noise amount of the fluid noise caused by turbulence generation in the duct and a duct diameter, in which the horizontal axis shows a frequency (the unit is Hz) and the vertical axis shows a noise amount (the unit is dB). In addition, FIG. 9B shows a graph in a case where the duct diameter is set to each of 25 mm, 50 mm, 100 mm, 150 mm, and 200 mm.

As can be seen from FIG. 9B, it is found that as the duct diameter decreases, the noise amount of fluid noise increases at a cutoff frequency. It is surmised that this is because as the duct diameter decreases, an acoustic Q value in a duct cross-sectional area direction increases. The cutoff frequency is determined in accordance with the duct diameter, and specifically, in a case where the sound speed is defined as c (m/s) and the diameter of the duct is defined as d (mm), a cutoff frequency fc (Hz) is calculated through relational expression (1).

$$fc = c / ( 2 \times d ) \qquad Relational expression ( 1 )$$

According to relational expression (1), a cutoff frequency in a case where the duct diameter is 150 mm or less is 1 kHz or more. In this case, according to the calculation result, the volume of fluid noise increases in a frequency band close to 1 kHz.

Based on the results, the present inventors have found that, as the diameter of the wind duct 12 decreases, fluid noise generated in the wind duct significantly increases with both the fluidic features and the acoustic features. In the blowing system S, as shown in FIG. 1, noise (hereinafter, referred to as composite noise) including fluid noise generated in the wind duct 12 and noise derived from the blowing source 10 having a component of a lower frequency than the fluid noise is propagated to the blowing target. In FIG. 1, the noise derived from the blowing source 10 is represented by a white arrow, and the fluid noise is represented by a black arrow.

In consideration of the phenomenon, the present inventors have closely studied a configuration of the wind duct with a silencer 100 that can efficiently reduce composite noise. To describe specifically, in the present embodiment, as shown in FIG. 10, the frequency of a primary silencing peak of the silencer 20 is within a frequency band of sound generated in the wind duct 12 due to the blowing in the wind duct 12 (that is, fluid noise). FIG. 10 is a schematic view showing a silencing spectrum of the silencer 20, a spectrum of noise generated by the blowing source 10, and a spectrum of the fluid noise. In FIG. 10, the horizontal axis shows the frequency, the vertical axis for the silencing spectrum shows the silencing degree (specifically, a transmission loss) of the silencer 20, and the vertical axis for the noise spectrum shows the intensity (specifically, the sound pressure) of noise.

The frequency of the primary silencing peak of the silencer 20 is the frequency of the peak of the lowest order in the silencing spectrum of the silencer 20. The silencing spectrum of the silencer 20 indicates the silencing degree of the silencer 20 at each frequency. The silencing degree is a measure indicating the silencing performance of the silencer 20, and indicates that the performance is higher as the silencing degree is larger, for example, as in the case of the transmission loss or a sound absorption rate. The transmission loss of the silencer 20 can be calculated from transmittance measured through acoustic pipe measurement. In an acoustic pipe measurement method, according to “ASTM E2611-09: Standard Test Method for Measurement of Normal Incidence Sound Transmission of Acoustical Materials Based on the Transfer Matrix Method”, a transmittance and reflectivity measurement system using a 4-terminal microphone (not shown) is prepared, and evaluation is performed. In this case, for example, in a case where an internal diameter of an acoustic pipe is set to 4 cm, measurement can be performed up to approximately 4,000 Hz by the measurement system. In addition, WinZacMTX manufactured by Nihon Onkyo Engineering Co., Ltd. can be used in the same measurement.

The frequency band of fluid noise is identified by measuring the spectrum of the fluid noise with the measurement system shown in FIG. 6. The frequency band of the fluid noise may be set according to noise intensity (specifically, a sound pressure) in the spectrum of the fluid noise, or for example, a range in which the sound pressure is equal to or larger than a predetermined value in the spectrum may be set as the frequency band of the fluid noise.

In addition, the frequency band of the fluid noise may be set with a frequency of a peak at which the sound pressure is maximum (hereinafter, a maximum peak frequency) in the spectrum as a reference. To describe specifically, on a low frequency side and a high frequency side of the maximum peak frequency, respectively, frequencies closest to the maximum peak frequency are defined as a lower limit frequency and an upper limit frequency, among frequencies at which a sound pressure is lowered from the sound pressure at the maximum peak frequency (that is, a maximum sound pressure) to a predetermined level P. A range from the lower limit frequency to the upper limit frequency determined in such a manner may be set as the frequency band of the fluid noise.

For the maximum peak frequency, an approximate curve may be acquired for a waveform of a spectrum of fluid noise measured by the measurement system of FIG. 6, and a frequency at which the sound pressure is maximum in the approximate curve may be set as a maximum peak frequency.

In addition, the predetermined level P may be determined as appropriate, for example, may be determined as a ratio with respect to the maximum sound pressure, and specifically, may be 1/10 times (corresponding to 10 dB).

As described above, in a case where the frequency of the primary silencing peak of the silencer 20 is within the frequency band of the fluid noise, the silencer 20 has characteristics of being capable of silencing in the frequency band of the fluid noise. In this case, as shown in FIG. 1, the silencer 20 may be provided at the middle position of the wind duct 12 and be disposed at a position closer to the exit among the blowing source 10 and the exit of the wind duct 12. That is, it is suitable that the silencer 20 is disposed on the downstream side of the half position in the wind duct 12. Accordingly, composite noise propagating in the wind duct 12 including the fluid noise can be efficiently silenced.

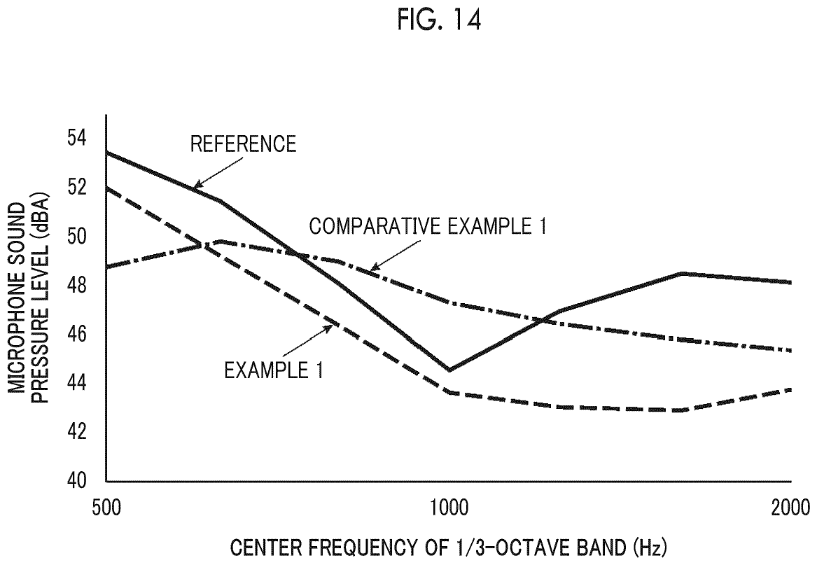

According to the present embodiment, as described above, by disposing the silencer 20 in which the frequency of the primary silencing peak is within the frequency band of the fluid noise on the downstream side (leeward side) closer to the exit of the wind duct 12, composite noise can be silenced as a whole (see FIG. 14). Herein, the frequency of the primary silencing peak of the silencer 20 is determined according to the type of the silencer 20, the shape and the structure of the silencer 20, and the type and the shape of the sound absorbing material 50 disposed in the silencer 20.

To describe specifically, in the silencer 20 shown in FIG. 2, the frequency of the primary silencing peak can be adjusted by changing the width (a length in the blowing direction) of the cavity in the expansion portion 28. To describe more specifically, the silencer 20 shown in FIG. 2 is a side branch type silencer, and the width of the cavity corresponds to the length of a side branch (denoted by a symbol L in FIG. 2). In addition, as described in Air Conditioning and Sanitary Engineering, Vol. 81, No. 1, p. 51, a length L (unit: m) of the side branch and a frequency f1 (unit: Hz) of the primary silencing peak satisfy relational expression (2) below.

$$f 1 = c / ( 4 \times L ) \qquad Relational expression ( 2 )$$

In addition, in the silencer 20X shown in FIG. 3, the frequency of the primary silencing peak can be adjusted by changing the width of the cavity in the expansion portion 28 (which is the length in the blowing direction and is denoted by a symbol W in FIG. 3). Specifically, a frequency f2 (unit: Hz) of the primary silencing peak in the silencer 20X and a width W (unit: m) of the cavity satisfy relational expression (3) below.

$$f 2 = c / ( 4 \times W ) \qquad Relational expression ( 3 )$$

In addition, in the silencers 20Y and 20Z shown in FIGS. 4 and 5, the frequency of the primary silencing peak can be adjusted by changing the size and the opening ratio of an opening (specifically, the hole 38 or the micro hole) and the volume of the rear space 42.

In addition, a silencing degree at each silencing peak including the primary silencing peak, in other words, silencing performance can be changed depending on the structure of the silencer 20 and the like. In view of this point, from a perspective of controlling the frequency of each silencing peak, it is preferable that the container 22 of the silencer 20 is composed of a material that is easily formed. Specifically, it is preferable that the container 22 is composed of a resin material.

In addition, an effect of efficiently silencing composite noise with the present embodiment can be prominent and more significant depending on the position where the silencer 20 is disposed, the diameter of the wind duct 12, blowing conditions, and the like. For example, in a case where the silencer 20 is disposed in the outdoor space where the blowing source 10 is disposed among the two spaces separated by the outer wall W, the effect is more significant.

To describe specifically, for a reason of making the blowing target room R quiet, the blowing source 10 tends to be placed in a space on a side opposite to the blowing target room R. In this case, by disposing the silencer 20 in which the frequency of the primary silencing peak is within the frequency band of fluid noise in the same space as the blowing source 10, the silencer 20 can appropriately silence noise derived from the blowing source 10.

However, the present invention is not limited thereto, and the silencer 20 may be disposed in the blowing target room R.

In addition, in a case where an average wind speed in a cross section of each portion of the wind duct 12 is 1 m/s or more, the effect is more significant. Herein, the average wind speed in the cross section is a wind speed calculated based on the amount of wind flowing in the wind duct 12 per unit time (for example, 1 second) and the cross-sectional area of the wind duct and is, for example, a wind speed obtained by simply dividing the amount of wind by the cross-sectional area. An anemometer is installed at the exit of the wind duct 12, and the amount of wind can be measured from a wind speed measured by the anemometer.

In a case where the average wind speed is 1 m/s or more, turbulence occurs in the wind duct 12, and fluid noise is easily generated, and an effect of efficiently silencing composite noise in consideration of the fluid noise is remarkably prominent. The average wind speed is preferably 1 m/s or more, may be more preferably 5 m/s or more, and may be particularly preferably 10 m/s or more.

In addition, in the present embodiment, the wind duct 12 penetrates the outer wall W, and as the size (diameter) of the through-hole decreases, the average wind speed increases. In a case where the diameter of the through-hole is 150 mm or less, as described above, fluid noise generated in the wind duct 12 noticeably increases due to a fluidic effect and an acoustic effect (specifically, features A and B described above). In this case, the effects are more prominently exhibited.

The diameter of the through-hole provided in the outer wall W is preferably 150 mm or less, may be more preferably 100 mm or less, and may be particularly preferably 50 mm or less.

In addition, in a case where an inner peripheral surface of the wind duct 12 includes an uneven region 12a where unevenness is formed as shown in FIG. 2, the effects are more significant. The uneven region 12a is, for example, a bellows-shaped region where mountains and valleys are alternately repeated in an extension direction of a hose, such as an inner peripheral surface of a Ty-Duct hose or a flexible hose. In addition, in an inner peripheral surface of a hose in which a helical wire is embedded, the uneven region 12a may be a region formed by regularly protruding a portion, in which the hose is embedded. In addition, the uneven region 12a may be a region where a portion that projects inward from a peripheral region or a portion that is buried with respect to the peripheral region is formed in a joint, a valve, or the like provided in the middle of the wind duct 12.

In a case where the uneven region 12a is included in the inner peripheral surface of the wind duct 12, since turbulence occurs more easily in the wind duct 12, fluid noise is more easily generated, and an effect of efficiently silencing composite noise in consideration of fluid noise is further prominently exhibited.

### EXAMPLES

Hereinafter, the present invention will be more specifically described with reference to examples. Materials, amounts used, ratios, the content of processing, processing procedures, and the like shown in the examples below can be changed as appropriate without departing from the gist of the present invention. Therefore, the scope of the present invention is not to be construed as limiting by the examples shown below.

### Example 1 and Comparative Example 1

A test (example 1) and a comparative test (comparative example 1) thereof conducted for the effect of the wind duct with a silencer according to the embodiment of the present invention will be described.

### Example 1

In example 1, the silencer 20X shown in FIG. 3 is used. The silencer 20X has a structure in which the sound absorbing material 50 is disposed in the expansion portion 28 (cavity) disposed at the middle position of the wind duct 12. The in-expansion portion wind duct 32 is provided in the expansion portion 28, and the tubular sound absorbing material 50 (product name: MICROMAT) is disposed at a position surrounding the in-expansion portion wind duct 32. That is, in the silencer 20X, the entire range of the in-expansion portion wind duct 32 is surrounded by the sound absorbing material 50. In the wind duct 12, the diameter of a portion other than the in-expansion portion wind duct 32 and the diameter of a hole portion of the sound absorbing material 50 (that is, the diameter of the in-expansion portion wind duct 32) are both 28 mm.

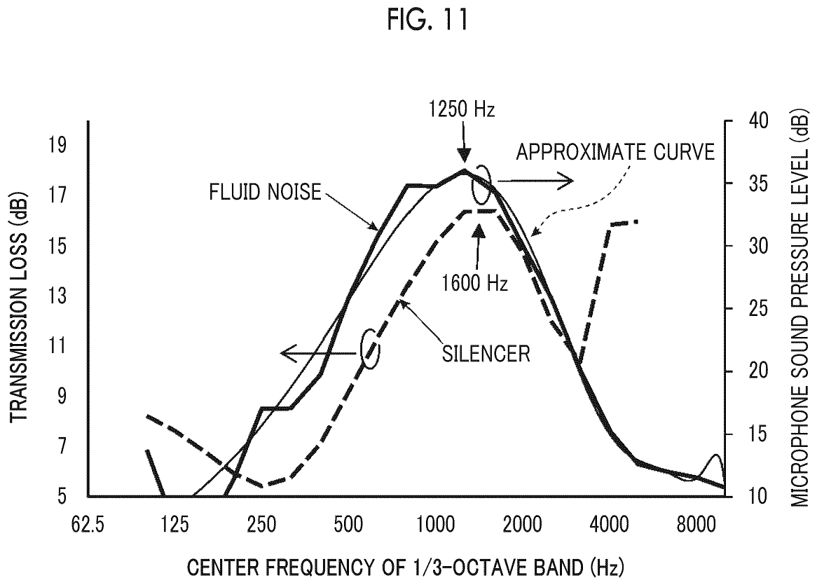

In addition, in example 1, the width W of the cavity in the expansion portion 28 is 60 mm, and the frequency of the primary silencing peak acquired from relational expression (3) is 1,400 Hz. As shown in FIG. 11, this value substantially matches the frequency (1,600 Hz) of the primary silencing peak in the silencing spectrum measured by the acoustic pipe to which the silencer 20X is connected.

FIG. 11 is a graph showing a silencing spectrum measured through the acoustic pipe measurement method and shows a silencing spectrum of the silencer 20X of example 1. In FIG. 11, the horizontal axis shows a center frequency (Hz) of a ⅓-octave band, and the vertical axis on the left side shows a transmission loss (dB).

In addition, FIG. 11 shows the spectrum of fluid noise in a case where the wind speed is 9 m/s in FIG. 7, together with the approximate curve thereof. The vertical axis on the right side in FIG. 11 shows the microphone sound pressure (dB) of the fluid noise.

As can be seen from FIG. 11, the frequency of the primary silencing peak measured for the silencer 20X of example 1 is within the frequency band of fluid noise in a case where the wind speed is 9 m/s. The frequency band of the fluid noise is set according to a sound pressure at the maximum peak frequency (=1,250 Hz) in the spectrum thereof. Specifically, frequencies at which a sound pressure is 17.5 dB obtained by further halving a sound pressure, which is ½ the maximum sound pressure (=35 dB), are acquired on the low frequency side and the high frequency side of the maximum peak frequency, and a range (300 to 3,000 Hz) in which the acquired frequencies are defined as a lower limit and an upper limit is defined as the frequency band of the fluid noise.

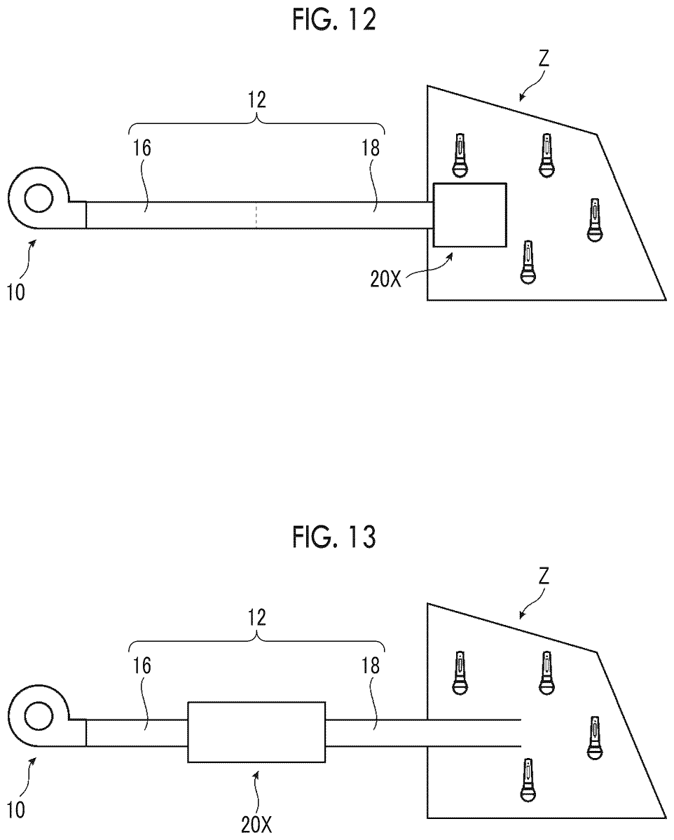

In example 1, a measurement system shown in FIG. 12 is created, and in a state where the blowing source 10 is operated to blow wind, the sound pressure of sound (that is, composite noise) released from a terminal of the downstream wind duct 18 is measured. The measurement system in example 1 has the same configuration of the “measurement test on wind speed dependence of fluid noise” described above except for the position where the silencer is disposed. In example 1, as shown in FIG. 12, the silencer 20X is disposed at a position closer to the exit of the downstream wind duct 18. In a strict sense, the silencer 20X is disposed such that the in-expansion portion wind duct 32 of the silencer 20 is continuous on the downstream side of the downstream wind duct 18, and the in-expansion portion wind duct 32 forms a terminal portion of the wind duct 12.

### Comparative Example 1

In comparative example 1, the silencer 20X having the same structure as in example 1 is used. In comparative example 1, a measurement system shown in FIG. 13 is created, and in a state where the blowing source 10 is operated to blow wind, the sound pressure of sound (that is, composite noise) released from the terminal of the downstream wind duct 18 is measured. The measurement system in comparative example 1 has the same configuration of the “measurement test on wind speed dependence of fluid noise” described above except for the position where the silencer is disposed. In comparative example 1, as shown in FIG. 13, the silencer 20X is disposed at a position closer to the blowing source 10. In this case, the in-expansion portion wind duct 32 of the silencer 20X is positioned between the upstream wind duct 16 and the downstream wind duct 18 and communicates (is continuous) with cach of the wind ducts 16 and 18.

### Measurement Results of Silencing Effects in Example 1 and Comparative Example 1

For each of example 1 and comparative example 1, measurement results of a silencing effect with respect to composite noise is shown in FIG. 14. The horizontal axis of FIG. 14 shows the center frequency (Hz) of the ⅓-octave band, and the vertical axis shows the microphone sound pressure (dB).

FIG. 14 also shows results of measuring the sound pressure of sound (composite noise) released from the terminal of the wind duct 12 in a case where the silencer is not disposed in the measurement system, as a reference.

In addition, a value obtained by integrating noise amounts (unit: dBA) in a band of 500 Hz to 2,000 Hz for each spectrum of FIG. 14 is shown in table 1.

TABLE 1

| | Noise |
|---|---|
| | Amount |
| | (dBA) |
| Reference | 58.0 |
| Example 1 | 55.7 |
| Comparative | 56.2 |
| Example 1 | |

As is clear from FIG. 14, in the system (example 1) in which the silencer 20X is disposed on the exit side of the wind duct 12, composite noise can be silenced over a wide range, and particularly, a larger silencing effect is obtained in a band of 1,000 Hz to 3,000 Hz in which the sound pressure of fluid noise increases. In addition, as can be seen from table 1, in a case where the silencer 20X is disposed on the exit side of the wind duct 12, the overall silencing effect further increases.

As described hereinbefore, as shown in example 1, the effects of the present invention are clear.

### EXPLANATION OF REFERENCES

10: blowing source
12: wind duct
12a: uneven region
14: wind duct forming member
16: upstream wind duct
18: downstream wind duct
20, 20X, 20Y, 20Z: silencer
22: container
24: entrance-side connecting portion
26: exit-side connecting portion
28: expansion portion
30: inner sleeve
32: in-expansion portion wind duct
34: opening portion
36: partition member
38: hole
40: porous plate
42: rear space
50: sound absorbing material
60: silencer for measurement
100: wind duct with silencer
R: blowing target room
S: blowing system
W: outer wall (wall)
Z: reverberation chamber

What is claimed is:

1. A wind duct with a silencer comprising:
a wind duct that is connected to a blowing source; and
a silencer that reduces sound released from an exit of the wind duct,
wherein the silencer is disposed at a position closer to the exit among the blowing source and the exit, and
a frequency of a primary silencing peak of the silencer is within a frequency band of sound generated in the wind duct due to blowing in the wind duct.

2. The wind duct with a silencer according to claim 1,
wherein the wind duct penetrates a wall separating two spaces, and
the silencer is disposed in a space where the blowing source is disposed, among the two spaces.

3. The wind duct with a silencer according to claim 2,
wherein the wind duct penetrates the wall constituting a building.

4. The wind duct with a silencer according to claim 1,
wherein the wind duct is connected to a fan that is the blowing source.

5. The wind duct with a silencer according to claim 1,
wherein a sound absorbing material is included inside the silencer, and
the sound absorbing material is composed of a material which is a non-metallic body and which is other than an inorganic substance.

6. The wind duct with a silencer according to claim 5,
wherein a part of the wind duct is provided in the silencer, and
in the silencer, the sound absorbing material is disposed at a position surrounding the part of the wind duct provided in the silencer.

7. The wind duct with a silencer according to claim 1,
wherein the silencer includes a container made of a resin.

8. The wind duct with a silencer according to claim 1,
wherein a wind speed calculated based on an amount of wind flowing in the wind duct per unit time and a cross-sectional area of the wind duct is 1 m/s or more.

9. The wind duct with a silencer according to claim 1,
wherein an inner peripheral surface of the wind duct includes an uneven region where unevenness is formed.

10. The wind duct with a silencer according to claim 2,
wherein the silencer is attached to a portion of the wind duct, which is disposed along the wall.

11. The wind duct with a silencer according to claim 2,
wherein the wind duct is connected to a fan that is the blowing source.

12. The wind duct with a silencer according to claim 2,
wherein a sound absorbing material is included inside the silencer, and
the sound absorbing material is composed of a material which is a non-metallic body and which is other than an inorganic substance.

13. The wind duct with a silencer according to claim 12,
wherein a part of the wind duct is provided in the silencer, and
in the silencer, the sound absorbing material is disposed at a position surrounding the part of the wind duct provided in the silencer.

14. The wind duct with a silencer according to claim 2,
wherein the silencer includes a container made of a resin.

15. The wind duct with a silencer according to claim 2,
wherein a wind speed calculated based on an amount of wind flowing in the wind duct per unit time and a cross-sectional area of the wind duct is 1 m/s or more.

16. The wind duct with a silencer according to claim 2,
wherein an inner peripheral surface of the wind duct includes an uneven region where unevenness is formed.

17. The wind duct with a silencer according to claim 3,
wherein the silencer is attached to a portion of the wind duct, which is disposed along the wall.

18. The wind duct with a silencer according to claim 3,
wherein the wind duct is connected to a fan that is the blowing source.

19. The wind duct with a silencer according to claim 3,
wherein a sound absorbing material is included inside the silencer, and
the sound absorbing material is composed of a material which is a non-metallic body and which is other than an inorganic substance.

20. The wind duct with a silencer according to claim 19,
wherein a part of the wind duct is provided in the silencer, and
in the silencer, the sound absorbing material is disposed at a position surrounding the part of the wind duct provided in the silencer.
